(19) United States
(12) Patent Application Publication
(10) Pub. No.: US 2007/0277645 A1
(43) Pub. Date: Dec. 6, 2007

(54) Lightweight Crankshaft

(76) Inventors: Karl Weisskopf, Rudersberg (DE); Tilman Haug, Weissenhorn (DE); Thomas Behr, Elchingen (DE)

Correspondence Address: AKERMAN SENTERFITT, P.O. BOX 3188, WEST PALM BEACH, FL, 33402-3188, US

(21) Appl. No.: 10/487,030

(22) PCT Filed: Aug. 13, 2002
(86) PCT No.: PCT/DE02/02964

§ 371 Date: Sep. 11, 2006

(30) Foreign Application Priority Data
Aug. 16, 2001 (DE) 101 40 332.1

(51) Int. Cl. F16C 7/00; F02B 75/32

(52) U.S. Cl. 74/579 E; 123/197.4

(57) ABSTRACT

A lightweight crankshaft (1), with eccentric structures, such as con-rods, main bearings, etc., comprises cavities (2, 3, 4, 5, 7, 10, 12) and/or recesses (8) for weight reduction, both in the region of the axis of rotation and isolated therefrom in the region of the eccentric structures. According to the invention at least one cavity is provided (2, 3, 4, 6, 7, 10, 12) in which a stabilizing filler material (5) is located. Said stabilizing filler material can, for example, be a metal foam.

### BACKGROUND OF THE INVENTION

1. Field of Invention

The invention relates to mechanical shafts as are used, for example, in drives. In particular, the invention relates to (partially) cast crankshafts and to a method for their production.

2. Related Art of the Invention

Drive shafts are subjected to high mechanical loads and are therefore conventionally manufactured from solid material (steel). With a dead weight of 12 to 40 kg, a solid crankshaft made of forged steel or nodular cast iron (GGG70) is therefore the heaviest engine component in motor vehicles.

A crankshaft which is not solid and is therefore lighter exerts a favorable influence on the rotational speeds which can be achieved and, owing to the reduction in moving masses, results in lower fuel consumption. Further positive secondary effects arise for mounting the shaft, the connecting rods, housing volume and starter generator and, owing to the reduction in the counterweight radius, make it possible for the overall height of the engine to be reduced.

In order to reduce the weight, there are technical attempts to design the core of the shaft to be hollow axially. Thus, patent specification DE 43 14 138 C1, inter alia, describes, for use as a crankshaft, a hollow shaft in which the core is manufactured from a steel pipe which is then inserted in a casting mold and encapsulated with the desired casting metal and, in the process, the particular eccentric structures (e.g. cam bodies) are then formed. To reduce the weight further in regions of the shaft which protrude eccentrically (cam bodies), it is proposed in the patent specification to widen the steel pipe core in these regions by compressive deformation in order thereby to save material (cast metal) even in these particularly heavy parts of the shaft.

In the case of a shaft manufactured in such a manner, possible savings on weight are in principle restricted, since only the central steel pipe (with compressive deformations) contributes to reducing the material. At the same time, a reduction in mass takes place only in the core region of the shaft, i.e. moments of inertia of eccentric regions at a relatively large axial distance are only insignificantly reduced. Another disadvantage of this method is that a compressive deformation of a steel pipe core (proposed wall thickness of up to 4 millimeters) at a number of locations distributed over the length of the shaft is relatively complex in terms of manufacturing (according to the teaching of the abovementioned patent specification, a sudden internal pressure load of up to 4000 bar is required). In addition, the compressive deformations themselves cause the central steel pipe to lose stability, since, firstly, the deformation in these regions means that the thickness of the wall is reduced and, secondly, local deviations from the symmetrical cylinder shape cause unfavorable distributions of stress to arise. For modern high-performance drives, as are used, for example, in vehicles, this crankshaft design may not satisfy the requirements with regard to stiffness, since the degree of deformation between the main bearing and lifting bearing would be much too large.

In addition, the specifications DE 4 85 336 C, DE 7 14 558 C and DD 22 40 disclose crankshafts in which cavities of different configuration are provided both in the region of the axis of rotation and in the region of the eccentric structures.

The printed specifications DE 74 27 967 U1 and DE 27 06 072 A1 describe cast crankshafts, the weight of which is reduced not by cavities, but rather by lateral recesses arranged in the region of the eccentric structures.

DE 10 22 426 B even goes one step further and designs virtually the entire crankshaft to be hollow.

A common feature of all of these crankshafts is that although advantages in terms of the weight of the crankshaft can be achieved by the cavities, the cavities and/or recesses cause a reduction in the strength or stiffness of the crankshaft in comparison with a solid construction.

Furthermore, DE 196 50 613 A1 discloses a component having a core made of metal foam. The component is produced by casting around the core of metal foam. Use of a component of this type in the form of a connecting rod is described in DE 100 18 064 A1.

DE 40 11 948 A1 describes providing fiber or foam material inserts, prior to them being encapsulated by casting, with a closed-pore layer of the subsequent material with which they are encapsulated, by dipping them into the melt. Specifically for the use of metal foam, DE 195 26 057 C1 also describes a method in which the component of metal foam, after it has been pressed, is coated by means of thermal spraying.

The abstract of JP 55-103112 A discloses crankshafts in which metallic cores which remain in the crankshaft are inserted during the casting. In the abstract of JP 56-131819 A, these cores are fastened during the casting to rectilinear pipes which serve for conducting oil in the crankshaft. The abstract of JP 55-078813 also describes the fastening of cores to the oil-conducting pipes of a crankshaft during the casting, although the cores are designed in another manner.

Finally, GB 4 81 928 discloses a crankshaft in which the cavities are additionally reinforced by transverse ribs.

### SUMMARY OF THE INVENTION

The invention proceeds from the prior art which has been explained. It is based on the object of developing a lightweight crankshaft and the corresponding production method where, on the one hand, a reduction in the dead weight of the shaft are achieved, and, on the other hand, the mechanical stability is to be maintained to the greatest possible extent, so that the disadvantages which have been explained can be better overcome and further advantages (for example, with regard to smoothness of running) can be achieved.

This object is achieved by a lightweight crankshaft having the features of claim 1. The corresponding production method is the subject matter of claim 6.

Further details of the invention and advantages of various embodiments emerge from the features of the subclaims.

The lightweight crankshaft according to the invention and the corresponding production method is described below with reference to preferred embodiments, reference being made to the figures and the reference numbers specified therein. FIGS. 1 to 6 show axial longitudinal sections through various embodiments of the lightweight crankshaft according to the invention, and FIG. 7 shows a proposed expansion to increase the stability of the lightweight crankshaft.

### BRIEF DESCRIPTION OF THE DRAWINGS

In detail,

FIG. 1 shows a first embodiment of the lightweight crankshaft with cylindrical cavities, which are filled with filling material, in the region of the axis of rotation and of eccentric structures;

FIG. 2 shows an alternative embodiment with partially cylindrical cavities, which are filled with filling material and have an angled profile, in the region of the eccentric structures;

FIG. 3 shows a further embodiment of the lightweight crankshaft, in which the cavities filled with filling material have a larger cross section in the interior of the material and taper toward the outer region;

FIG. 4 shows another embodiment with conical recesses in the region of the axis of rotation and of the eccentric structures;

FIG. 5 shows a further embodiment in which cavities which are closed on all sides and are filled with stabilizing material are made in the interior of the material of the lightweight crankshaft;

FIG. 6 shows an example for fixing cores of stabilizing material or hollow reinforcing elements during the casting of the lightweight crankshaft;

FIG. 7 shows a cross section through one of the cavities in the lightweight crankshaft, a transverse rib being inserted to reinforce the stability.

### DETAILED DESCRIPTION OF THE INVENTION

In comparison with forged crankshafts, cast crankshafts have, on account of the material, a lower stiffness (axial, flexural and torsional stiffness) which is due to the lower modulus of elasticity (steel: 210,000 MPa; spherulitic graphite iron: 160,000 MPa). However, because of the great freedom in configuration and design during casting, this disadvantage can be reduced by structural measures, such as ribbing(s) or an optimization of the force flux by means of special shaping.

The invention makes use of the possibility which exists because of the casting of providing the shaft or the bearings in a specific manner with cavities and/or recesses. A hollow configuration of this type may—depending on the type of shaft —result in a reduction in weight of the shaft of up to 50%. The hollow configuration of the bearings is generally associated with a reduction in the stiffness of the component. This disadvantage can largely be overcome by special shaping of the cavities or recesses, since the geometry of the hollow configuration has a significant effect on the level of reduction in stiffness (axial, flexural and torsional stiffness). The casting manufacturing method enables a very great variety of geometries for the cavities to be represented (for example, conical, cylindrical, closed, open on one side, open on two sides), it also being possible for the shape to vary via the cross section.

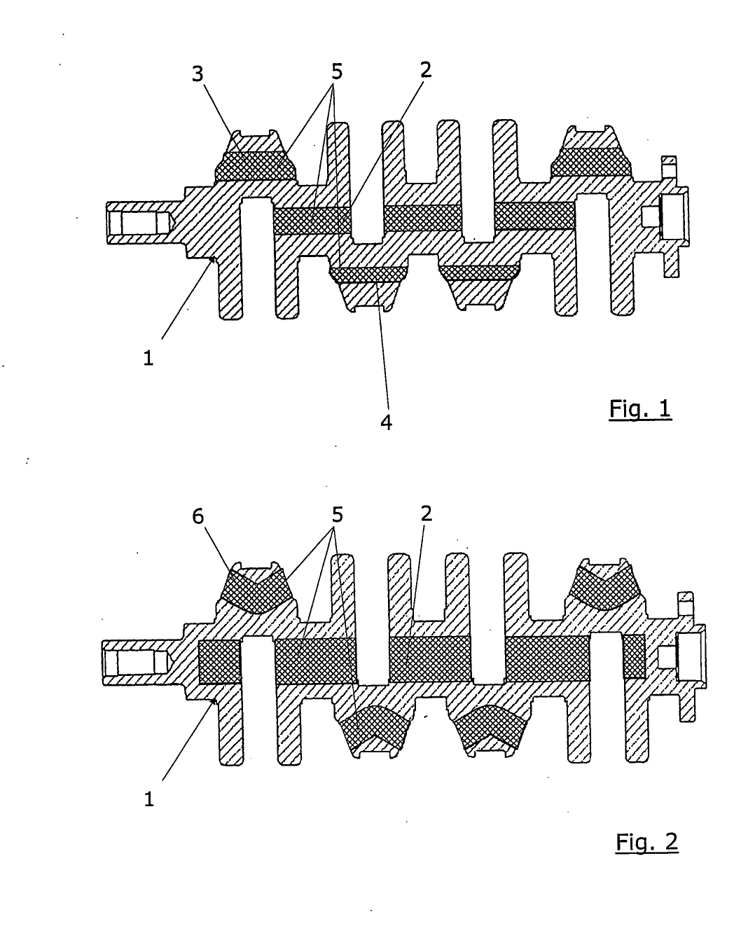

FIG. 1 illustrates a particularly simple (and therefore cost-effective) variant of the lightweight crankshaft (1) according to the invention. In this embodiment, cylindrical cavities (2) are firstly provided in the core of the shaft (1) along the main axis and further cylindrical cavities (3, 4) are arranged eccentrically in the region of the bearings. In this case, the cavities provided in the different regions can have different diameters (cf. 3 and 4) in order to take account of the particular loads at different points of the shaft. In this simple variant, cavities of identical geometrical shape (cylinders) and identical orientation (cylinder axis parallel to the axis of rotation of the shaft) are illustrated. Without an additional outlay in terms of manufacturing, simple cylindrical cavities may also have different orientations (cylinder axis at an angle with respect to the axis of rotation) (not illustrated).

For the purpose of mechanical reinforcement, a stiffening filling material (5) is placed into the cavities. For this purpose, use is preferably made of materials which, on the one hand, can withstand a high mechanical load and, on the other hand, have a significantly lower weight in comparison with the solid material of the shaft. A filling of the cavities (main and connecting rod bearings) with metal foam, for example, results in a considerable stiffening with only a slight increase in mass of the crankshaft. Depending on priority—weight saving or strength—different materials, for example aluminum, zinc, iron, steel and alloys, can be used.

On the one hand, the metal foams can be inserted in the form of lost casting cores (remaining in the crankshaft) as early as during the casting process (in this case the melting point of the foam has to be higher than that of the casting material, e.g. steel foam) or else afterwards by foaming the cavities with an appropriate semi-finished product (for example consisting of metal powder and foaming agent, for example titanium hydride, followed by a heat treatment by means of a furnace or inductively). As an alternative, small pieces of metal foam can be placed through the remaining openings (cf. the following exemplary embodiments) into the cavities and be bonded there. This variant is of interest in particular for the embodiment which will be explained below in accordance with FIG. 4.

The use of metal foam as stabilizing filling material has the additional advantage that natural vibrations of the shaft are damped during running. As a result, the smoothness of running (acoustics, vibration) of the shaft is significantly improved.

As an alternative to the filling material (5) of metal foam, the cavities can also be stabilized by being filled with iron or steel hollow balls of identical or different diameter. To fix them within the cavities, the iron or steel hollow balls are bonded to one another, or are fastened, for example inductively welded, to one another or to an auxiliary construction (metal pin, metal pipe).

FIG. 2 shows an exemplary embodiment in which “angled” cavities (6) having a cylindrical profile in some sections (in the manner of a bent pipe) are provided in eccentric regions of the shaft. This changed geometry brings about a significant increase in the stiffness, so that the mechanical load-bearing capacity of the shaft is largely maintained despite the reduction in weight. The force flux in the region of the cavity can be defined by selection of the angle, an angle range of between 15° and 45° being advantageous for most requirements, but, of course, other values are not ruled out either. FIG. 2 illustrates a shaft (1) which has such cavities (6) having an exclusively identical shape (angle, diameter). In a departure from the exemplary embodiment illustrated, different “angled” cavities (i.e. variation in angle and diameter) can be used in a shaft for adaptations to the loads which differ locally.

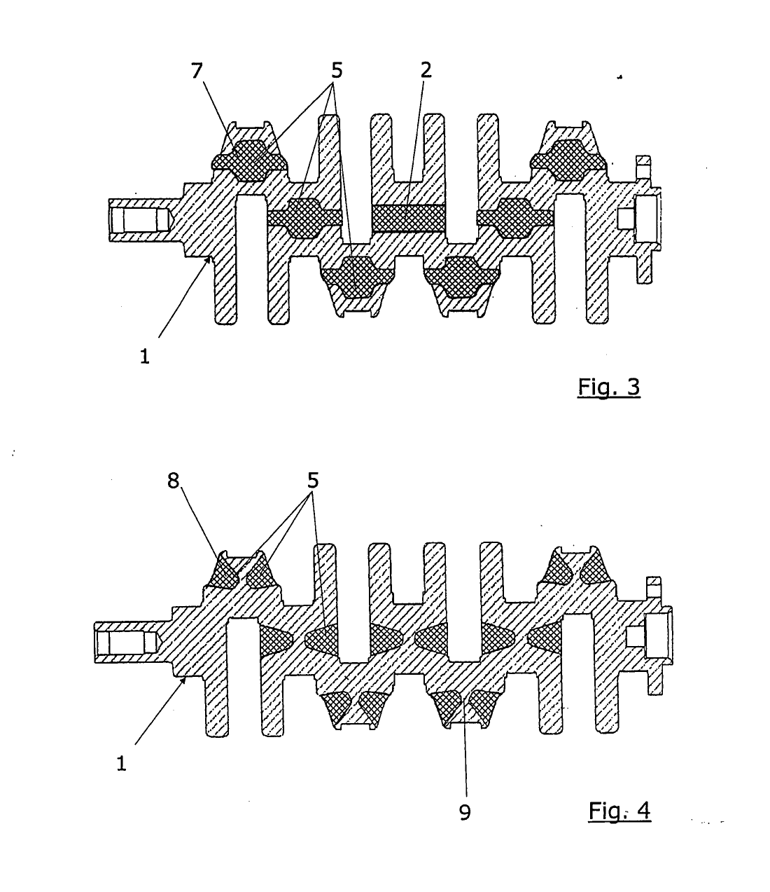

An alternative exemplary embodiment is illustrated in FIG. 3 in which there are cavities (7) of varying cross section and virtually closed outer contour. Owing to the expanded shape of these cavities in the inner region, the reduction in material is relatively high and at the same time the distribution of stress is favorably influenced, so that higher loads are possible. These cavities can be provided in different regions (axially, eccentrically) of the shaft and can also be combined with differently shaped cavities (2).

Another possibility for reducing the weight is illustrated in FIG. 4. In this variant, rather than using continuous cavities, cavern-like recesses (8) are provided axially or in eccentric regions of the shaft. In this case, the shape of the recesses may, as illustrated, be conical (also with different opening angles, preferably of between 15°-45°). Similarly, the recesses can be orientated differently with respect to one another and with respect to the axis of rotation of the shaft. Varying sizes and different shapes (dome, spherical segment, elliptical section, truncated cone, etc.) are likewise possible (not illustrated). There is preferably a larger diameter at the entrance to the bearings and a smaller diameter toward the center of the bearings in order to optimize the stiffness and also to make it possible for oil to be conducted in this region.

In the variant illustrated, identical recesses are arranged symmetrically in pairs, as a result of which webs (9) which have a stabilizing effect remain between the recesses. In principle, however, a combination of the different designs of recesses and cavities in a shaft may also be advantageous for specific load stipulations.

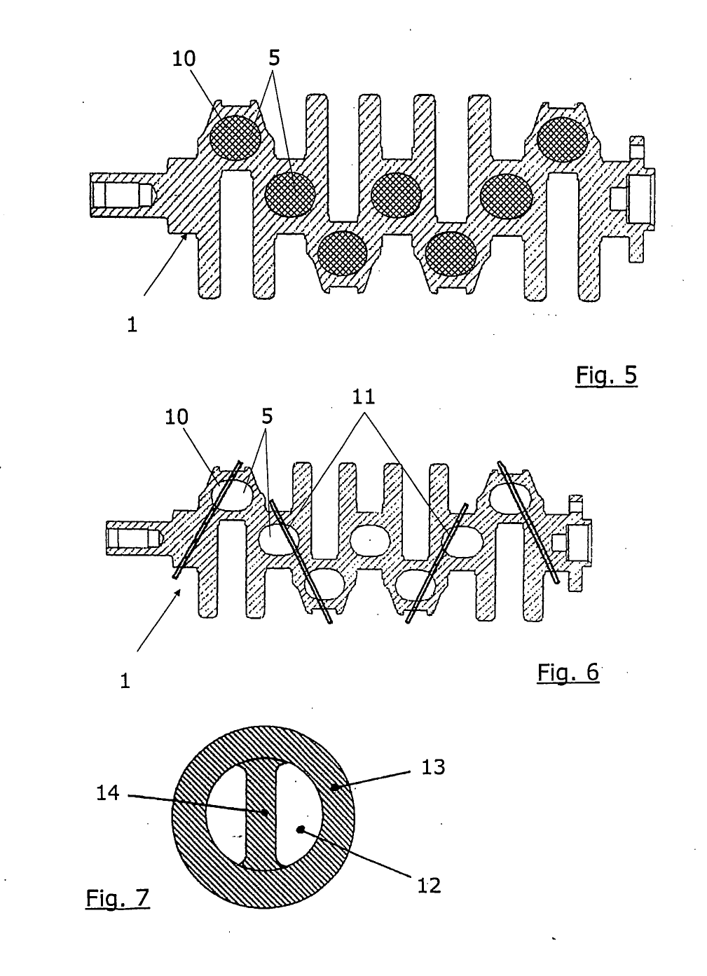

A mechanically particularly stable embodiment is illustrated in FIG. 5. In this case, the weight-reducing cavity (10) is embedded completely closed, without openings, in the material of the shaft. As a result and by virtue of appropriate shaping (for example, elliptical, spherical), this variant delivers the highest load values in respect of the force flux, which values—as illustrated in FIG. 12—can be further optimized by stabilizing filling material (5).

For the production of a variant of this type of the lightweight crankshaft, during the casting an appropriately shaped, high-melting metal foam is fixed at the appropriate positions and thereby completely sealed in as the displacer (e.g. an ellipse). FIG. 6 shows the fixing of the reinforcing elements or metal-foam displacers (not illustrated here and can only be identified in the form of the corresponding cavities) in the casing mold by metal pipes (11) which preferably consist of a high-melting iron or steel material and at the same time can constitute the oil duct. The reinforcing elements/metal-foam bodies to be inserted are already connected, for example by welding, before they are inserted, to the metal pipes which are to be sealed in.

For the use of displacers consisting of metal foam, a foam which is closed in the outer surface (i.e. is pore-free) is advantageous, said foam preventing the casting melt from penetrating and therefore preventing a possible filling of the foam bubbles of the displacer. This may alternatively also be achieved by coating the metal foam, for example with steel sheet. Iron or steel hollow balls may also be coated and sealed in as filling material (5) in the same manner.

In principle, in all of the abovementioned exemplary embodiments, a further increase in the stiffness of the lightweight crankshaft can be brought about by inserting transverse ribs into the cavities and/or recesses. FIG. 7 shows, as an example, a cross section through a cavity (12) having a transverse rib (14) fixed (by bonding, welding) on the wall (13). A transverse rib (14) may also be cast on directly, for example using divided casting cores. Position, strength and number of the transverse ribs may be matched to the force profile. Depending on the load, the “bracing” may consist of a continuous transverse rib (14) or of a plurality of continuous transverse ribs (not illustrated) or else of a plurality of non-continuous ribs of very different geometry (not illustrated).

Stabilizing filling materials (5), such as metal foam, hollow balls etc. (not illustrated here and can only be identified in the form of the corresponding cavities) are combined with the inserted transverse ribs (14).

In order to set the boundary surfaces between the displacers and the casting material and in order to prevent the displacers from melting on, a complete or partial coating of the displacers is conceivable. Furthermore, the coating prevents the diffusion of carbon from the melt into the displacers, which would have a negative effect on the mechanical characteristic values. This coating can be applied by means of thermal spraying processes (for example electric arc spraying, plasma coating), sol gel, electroplating or as black washes (Al₂O₃, Y₂O₃/Al₂O₃, TiO₂/Al₂O₃, MgAl₂O₄, Zr/Al silicate, NiCrAlY— and NiTi-layers, boron nitride; metal oxides in general).

The constructions which have been described and which are optimized in terms of stiffness can be used in principle for all customary casting alloys for crankshafts (for example spherulitic graphite iron according to DIN EN 1563). Moreover, the use of austempered cast iron (ADI Austempered Ductile Iron) according to DIN EN 1564 provides the possibility, on account of the subsequent heat treatment, of dissipating the stresses which may have arisen due to displacers being sealed in.

1-11. (canceled)

12. A cast lightweight crankshaft (1) with eccentric structures, such as connecting rods, main bearings etc., having, for the purpose of reducing weight, cavities (2, 3, 4, 6, 7, 10, 12) and/or recesses (8) both in the region of the axis of rotation and isolated therefrom in the region of the eccentric structures, wherein:
there is at least one cavity (2, 3, 4, 6, 7, 10, 12) and/or at least one recess (8) in which stabilizing filling material (5) is situated, and
to increase the mechanical load-bearing capacity of the shaft (1), at least one cavity (2, 3, 4, 6, 7, 10, 12) and/or at least one recess (8) is specially designed or arranged in such a manner
that the at least one cavity (2, 3, 4, 6, 7, 10, 12) and/or the at least one recess (8) is of angled design,
or that the at least one cavity (2, 3, 4, 6, 7, 10, 12) is completely sealed in the material of the shaft.

13. The lightweight crankshaft (1) as claimed in claim 12, wherein the stabilizing filling material (5) consists of metal foam.

14. The lightweight crankshaft (1) as claimed in claim 13, wherein the metal foam is aluminum, zinc, iron or steel foam.

15. The lightweight crankshaft (1) as claimed in claim 12, wherein at least one of the cavities (2, 3, 4, 6, 7, 10, 12) has a transverse rib (14).

16. The lightweight crankshaft (1) as claimed in claim 12, wherein the stabilizing filling material consists of iron or steel hollow balls.

17. A method for producing a lightweight crankshaft (1), comprising:
using displacers both in the region of the axis of rotation of the lightweight crankshaft (1) and in the region of eccentric structures during the casting, so that cavities (2, 3, 4, 6, 7, 10, 12) and/or recesses (8) are formed in these regions, comprising
using a stabilizing filling material (5) as the displacer,
using at least one recess of angled design, and/or
arranging at least one displacer in such a manner that it is completely enclosed during the casting.

18. The method as claimed in claim 17, wherein when metal foam is used as the displacer, said foam is coated before being sealed in.

19. The method as claimed in claim 17, wherein metal foam having an at least partially closed-pore surface is used as the displacer.

20. The method as claimed in claim 17, wherein the displacers are fastened to auxiliary constructions (11), for example metal pins or metal pipes, or to oil-conducting pipes, so that they are fixed during the casting.

21. The method as claimed in claim 17, wherein before being sealed in, the displacers and/or auxiliary constructions (11) are at least partially coated with a material preventing the diffusion of carbon.

22. The method as claimed in claim 21, wherein the coating is applied by means of thermal spraying processes (for example electric arc spraying, plasma coating), electroplating or as black washes (for example Al₂O₃, Y₂O₃/Al₂O₃, TiO₂/Al₂O₃, MgAl₂O₄, Zr/Al silicate, NiCrAlY— and NiTi-layers, boron nitride).
